(19) United States
(12) Patent Application Publication
(10) Pub. No.: US 2019/0353542 A1
(43) Pub. Date: Nov. 21, 2019

(54) PRESSURE DETECTION CLOTH

(71) Applicant: FUJITSU LIMITED, Kawasaki-shi (JP)

(72) Inventors: Shinichi TAJIMA, Kawasaki (JP); Shunji Baba, Yokohama (JP)

(73) Assignee: FUJITSU LIMITED, Kawasaki-shi (JP)

(21) Appl. No.: 16/378,981

(22) Filed: Apr. 9, 2019

(30) Foreign Application Priority Data
May 16, 2018 (JP) 2018-094232

(51) Int. Cl. G01L 5/00; D06N 7/00

(52) U.S. Cl. CPC G01L 5/0052; D06N 2209/041; D06N 7/00

(57) ABSTRACT

A pressure detection cloth includes a first cloth, a second cloth, a spacer formed between the first cloth and the second cloth, a gap formed by the spacer between the first cloth and the second cloth, a first conductive thread formed over a first surface exposed to the gap of the first cloth, and a second conductive thread formed over a second surface exposed to the gap of the second cloth, wherein the first surface and the second surface are opposed to each other, and wherein the first conductive thread and the second conductive thread are coupled to each other by a pressure of at least the first cloth and the second cloth.

### CROSS-REFERENCE TO RELATED APPLICATION

This application is based upon and claims the benefit of priority of the prior Japanese Patent Application No. 2018-094232, filed on May 16, 2018, the entire contents of which are incorporated herein by reference.

### FIELD

The embodiments discussed herein are related to a pressure detection cloth.

### BACKGROUND

For example, there is a conductive fabric in which intersecting conductors are separated from each other at intersections, and when a pressure is applied vertically to the surface of the fabric, the conductors are electrically connected to each other.

Further, for example, there is a pressure sensitive sensor in which an upper cloth portion and a lower cloth portion in which conductive threads are sewn linearly are overlapped such that the conductive threads are aligned perpendicular to each other, and a spacer of which an electrical characteristic value such as a resistance value or an electrical capacitance varies by a pressurization is sandwiched between the upper cloth portion and the lower cloth portion.

Related techniques are disclosed in, for example, Japanese National Publication of International Patent Application No. 2003-529901 and Japanese Laid-open Patent Publication No. 2009-042108.

### SUMMARY

According to an aspect of the invention, a pressure detection cloth includes a first cloth, a second cloth, a spacer formed between the first cloth and the second cloth, a gap formed by the spacer between the first cloth and the second cloth, a first conductive thread formed over a first surface exposed to the gap of the first cloth, and a second conductive thread formed over a second surface exposed to the gap of the second cloth, wherein the first surface and the second surface are opposed to each other, and wherein the first conductive thread and the second conductive thread are coupled to each other by a pressure of at least the first cloth and the second cloth.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic cross-sectional view illustrating a configuration of a pressure detection cloth according to an embodiment;

FIGS. 2A and 2B are schematic views illustrating that a detection unit is provided as the pressure detection cloth according to an embodiment;

FIG. 3A is a schematic view illustrating that the detection unit is provided as the pressure detection cloth according to an embodiment, and FIG. 3B is a circuit diagram thereof;

FIGS. 4A to 4C are schematic views illustrating an example of a power supply used for the detection unit provided in the pressure detection cloth according to an embodiment;

FIGS. 5A and 5B are schematic views for describing a method for manufacturing a pressure detection cloth according to an embodiment, in which FIG. 5A is a plan view and FIG. 5B is a cross-sectional view taken along line A-A and line B-B in FIG. 5A;

FIGS. 6A and 6B are schematic views for describing a method for manufacturing a pressure detection cloth according to an embodiment, in which FIG. 6A is a plan view and FIG. 6B is a cross-sectional view taken along line A-A in FIG. 6A;

FIGS. 7A and 7B are schematic views for describing a method for manufacturing a pressure detection cloth according to an embodiment, in which FIG. 7A is a plan view and FIG. 7B is a cross-sectional view taken along line A-A in FIG. 7A;

FIGS. 8A and 8B are schematic views for describing a method for manufacturing a pressure detection cloth according to an embodiment, in which FIG. 8A is a plan view and FIG. 8B is a cross-sectional view taken along line A-A in FIG. 8A;

FIGS. 9A and 9B are schematic views for describing a method for manufacturing a pressure detection cloth according to an embodiment, in which FIG. 9A is a plan view and FIG. 9B is a cross-sectional view taken along line A-A in FIG. 9A;

FIG. 10 is a schematic exploded perspective view illustrating a modification of the pressure detection cloth according to an embodiment;

FIG. 11 is a schematic exploded perspective view illustrating a modification of the pressure detection cloth according to an embodiment;

FIG. 12 is a schematic plan view illustrating another configuration of the pressure detection cloth according to an embodiment;

FIG. 13 is a schematic exploded perspective view illustrating another configuration of the pressure detection cloth according to an embodiment;

FIGS. 14A and 14B are schematic views for describing a method for manufacturing another configuration of the pressure detection cloth according to an embodiment, in which FIG. 14A is a plan view and FIG. 14B is a cross-sectional view taken along line A-A and line B-B in FIG. 14A;

FIGS. 15A and 15B are schematic views for describing a method for manufacturing another configuration of the pressure detection cloth according to an embodiment, in which FIG. 15A is a plan view and FIG. 15B is a cross-sectional view taken along line A-A in FIG. 15A;

FIGS. 16A and 16B are schematic views for describing a method for manufacturing another configuration of the pressure detection cloth according to an embodiment, in which FIG. 16A is a plan view and FIG. 16B is a cross-sectional view taken along line A-A in FIG. 16A; and

FIG. 17 is a schematic exploded perspective view illustrating a modification of another configuration of the pressure detection cloth according to an embodiment.

### DESCRIPTION OF EMBODIMENTS

In the related art, it is difficult to adjust a sensitivity according to a magnitude of a pressure (sensed pressure) applied to the conductive thread or the conductor.

Hereinafter, an embodiment of a technique for implementing a pressure detection cloth capable of changing the sensitivity of detection of a pressure when detecting the pressure using the conductive thread will be described with reference to the accompanying drawings.

The pressure detection cloth according to the embodiment is a pressure detection cloth capable of detecting the pressure using the conductive thread. This pressure detection cloth may be utilized for the pressure detection and has flexibility, so that it is possible to implement a pressure detection sensor which is difficult to break down. Further, the pressure detection cloth may also be referred to as a cloth-like (fabric-like) pressure detection sensor. In addition, the pressure detection cloth may also be used as, for example, an impact detection cloth capable of detecting an impact. In this case, “pressure” may be changed and read as “impact.”

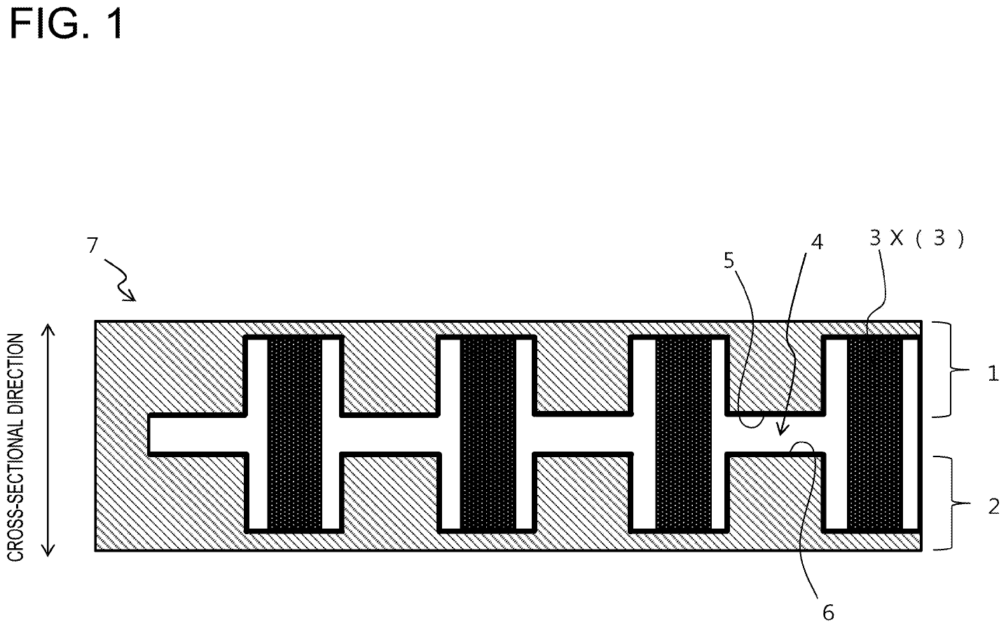

In the embodiment, as illustrated in FIG. 1, the pressure detection cloth includes a first cloth portion 1, a second cloth portion 2, a spacer portion 3 formed between the first cloth portion 1 and the second cloth portion 2, a gap portion 4 formed by the spacer portion 3 between the first cloth portion 1 and the second cloth portion 2, and a first conductive thread 5 and a second conductive thread 6 that are provided on the surfaces exposed to the gap portion 4 and opposed to each other, as the surfaces of the first cloth portion 1 and the second cloth portion 2, respectively, and are electrically connected to each other by a pressure.

Here, the first conductive thread 5 is provided from one side toward the other side of the first cloth portion 1. In addition, in FIG. 1, the first conductive thread 5 is provided from one side toward the other side in a left-right direction. Further, the second conductive thread 6 is provided from one side toward the other side of the second cloth portion 2 along the first conductive thread 5. In addition, in FIG. 1, the second conductive thread 6 is provided from one side toward the other side in the left-right direction.

Further, here, the respective first conductive thread 5 and second conductive thread 6 are provided linearly and in parallel to each other, but are not limited thereto. For example, the first conductive thread 5 and the second conductive thread 6 may be provided in a planar shape or in a lattice shape, respectively, so as to face each other. Further, for example, the respective first conductive thread 5 and second conductive thread 6 may be provided linearly to intersect (e.g., perpendicularly to) each other while being spaced apart from each other in plane view. In addition, for example, the first conductive thread 5 and the second conductive thread 6 formed linearly and in parallel to each other may be provided at a plurality of locations.

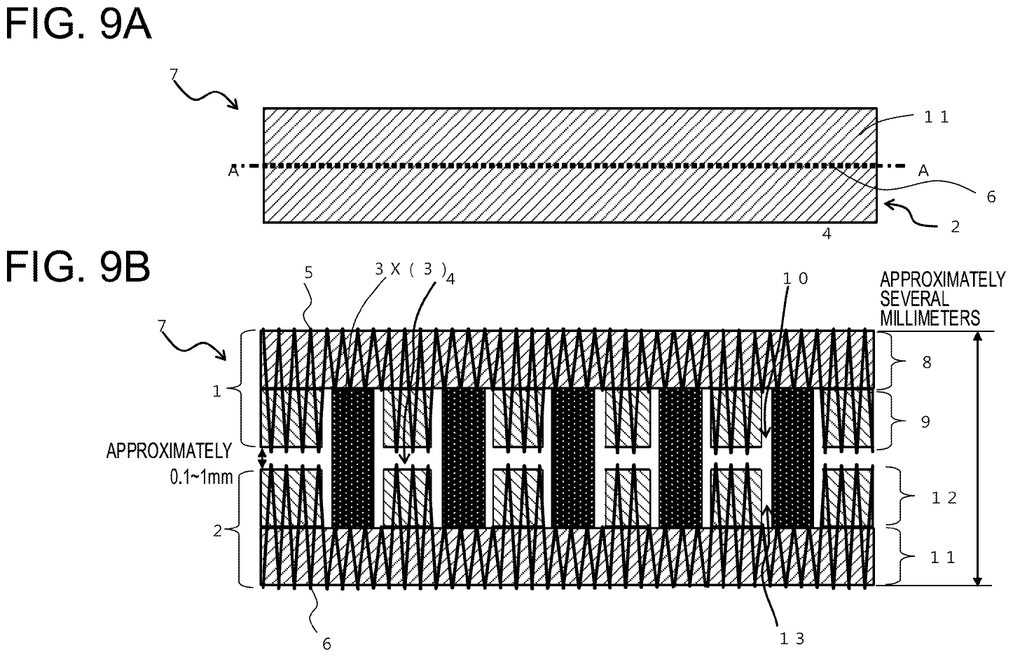

The first conductive thread 5 is sewed between both the lateral surfaces of the first cloth portion 1 in the thickness direction of the first cloth portion 1 (e.g., see FIG. 9B). Further, the second conductive thread 6 is sewed between both the lateral surfaces of the second cloth portion 2 in the thickness direction of the second cloth portion 2 (e.g., see FIG. 9B).

The surfaces exposed to the gap portion 4 and opposed to each other are the surfaces opposed to each other in the thickness direction (the direction perpendicular to the cloth surface; the direction vertical to the cloth; the thickness direction of the cloth; the cross-sectional direction of the cloth) of the first cloth portion 1 (or the second cloth portion 2). In addition, the first conductive thread 5 and the second conductive thread 6 are electrically connected to each other by the pressure in the thickness direction of the first cloth portion 1 (or the second cloth portion 2), that is, the direction perpendicular to the cloth surface.

Therefore, the pressure detection cloth 7 of the embodiment detects the pressure in the thickness direction of the first cloth portion 1 (or the second cloth portion 2), that is, the direction perpendicular to the cloth surface. In this case, it is possible to change the sensitivity of the pressure detection according to the size of the gap portion 4, that is, the distance between the surfaces exposed to the gap portion 4 and opposed to each other.

In the embodiment, the spacer portion 3 is configured by support members 3X. That is, the spacer portion 3 is constituted by the support members 3X made of a material different from that of the other portion of the pressure detection cloth 7.

Here, each support member 3X may be a nonconductive member, and an elastic member such as, for example, rubber may be used. In this case, it is possible to change the sensitivity of the pressure detection according to not only the size of the gap portion 4, that is, the distance between the surfaces exposed to the gap portion 4 and opposed to each other, but also, for example, the hardness, elastic modulus, or size of the support members 3X such as hardness or size of the rubber.

Even when the support members 3X do not undergo a deformation such as elastic deformation, the pressure detection cloth 7 is deformed in the direction perpendicular to the cloth surface due to the pressure, so that the gap portion 4 is closed, and as a result, the first conductive thread 5 and the second conductive thread 6 provided on the opposing surfaces, respectively, are electrically connected to each other. Therefore, the pressure may be detected.

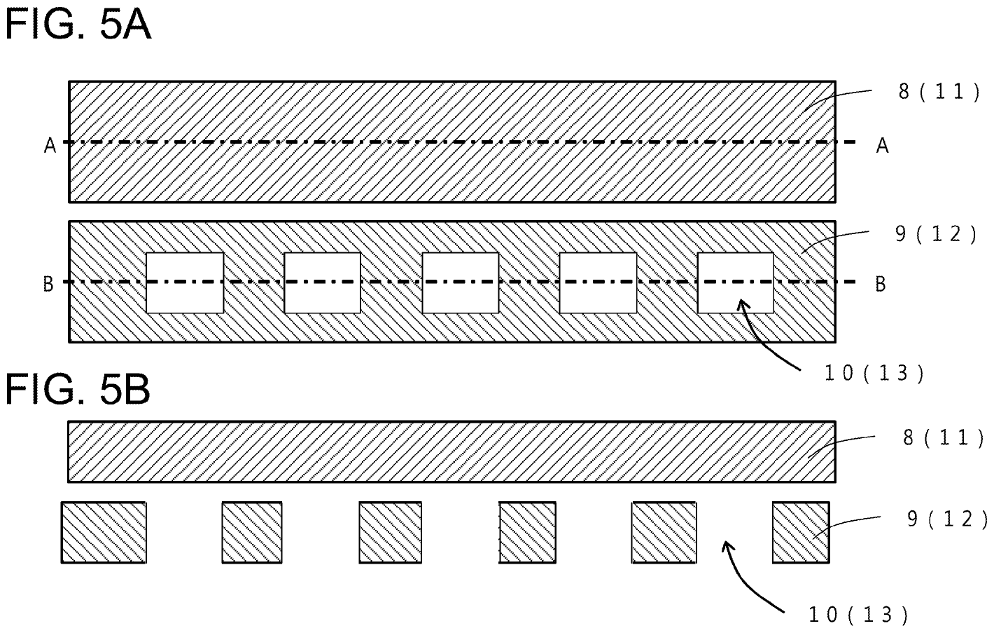

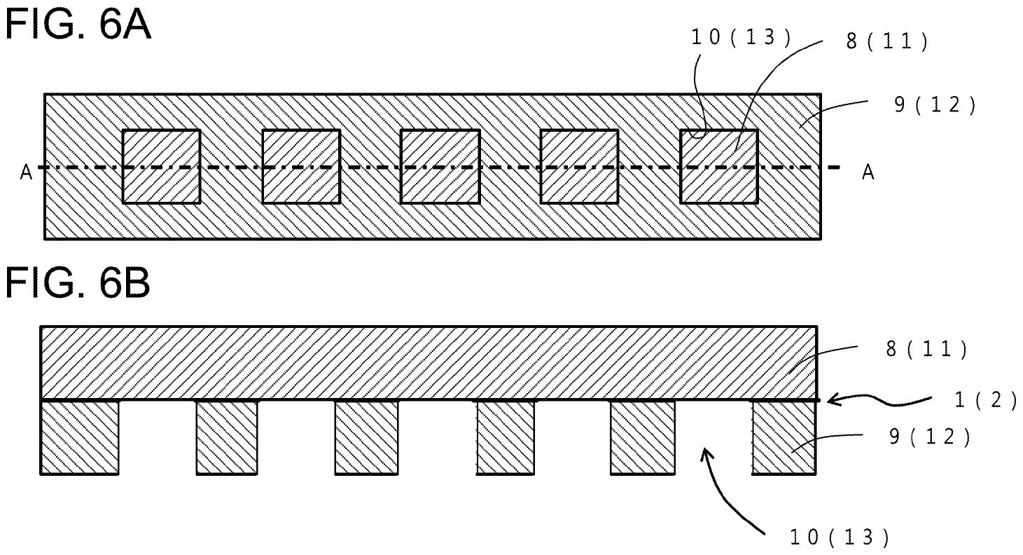

The first cloth portion 1 is configured by a first cloth 8 and a second cloth 9 having a plurality of first openings 10 (see, e.g., FIGS. 5A, 5B, 6A, and 6B). Here, the plurality of first openings 10 are formed at regular intervals.

The second cloth portion 2 is configured by a third cloth 11 and a fourth cloth 12 having a plurality of second openings 13 (see, e.g., FIGS. 5A, 5B, 6A, and 6B). Here, the plurality of second openings 13 are formed at regular intervals.

The first conductive thread 5 is sewed between one surface of the first cloth 8 and one surface of the second cloth 9 which are positioned on both sides of the first cloth portion 1 in the thickness direction of the first cloth portion 1 (see, e.g., FIG. 9B).

The second conductive thread 6 is sewed between one surface of the third cloth 11 and one surface of the fourth cloth 12 which are positioned on both sides of the second cloth portion 2 in the thickness direction of the second cloth portion 2 (see, e.g., FIG. 9B).

In addition, the first cloth portion 1 and the second cloth portion 2 are bonded to each other such that in a state where the plurality of first openings 10 and the plurality of second openings 13 are opposed to each other, respectively, and the support members 3X are provided in spaces configured by the opposing first openings 10 and second openings 13, respectively, the gap portion 4 is formed between the plurality of support members 3X, and the first conductive thread 5 and the second conductive thread are formed on the surfaces opposed to each other in the thickness direction of the first cloth portion 1 (or the second cloth portion 2), that is, the surfaces exposed to the gap portion 4 and opposed to each other in the direction perpendicular to the cloth surface, respectively (see, e.g., FIG. 9B).

Here, the thickness of the pressure detection cloth 7 obtained by bonding the first cloth portion 1 and the second cloth portion 2 to each other is approximately several millimeters, and the gap portion is approximately 0.1 to approximately 1 mm (see, e.g., FIG. 9B).

Further, here, the space in which the support members 3X are installed is larger than the space that constitutes the gap portion 4. That is, the distance between the surfaces in contact with both the ends of each support member 3X is larger than the distance between the surfaces exposed to the gap portion 4 and opposed to each other. Therefore, the support members 3X are held and fixed inside the space configured by the first openings 10 of the first cloth portion 1 and the second openings 13 of the second cloth portion 2.

The present disclosure is not limited to the configuration described above. For example, two first openings may be provided as the plurality of first openings 10, and two second openings may be provided as the plurality of second openings 13. The support members 3X may be installed in the two spaces configured by the first and second openings, respectively, and one gap portion 4 may be formed between the two support members 3X. Further, here, the cross-sectional shapes of the first openings 10 and the second openings 13 are quadrangular shapes (see, e.g., FIG. 5A), but are not limited thereto. For example, the cross-sectional shapes of the first openings 10 and the second openings 13 may have other shapes such as a circular shape.

According to the configuration described above, it may be understood that the pressure detection cloth 7 includes the support members 3X inside the cloth, and the gap portion 4 between the support members 3X, the first conductive thread 5 sewed between the upper surface of the gap portion 4 and the upper surface of the cloth through the upper surfaces of the support members 3X, and the second conductive thread 6 sewed between the lower surface of the gap portion 4 and the lower surface of the cloth through the lower surfaces of the support members 3X, inside the cloth, so as to detect the pressure by the electrical connection between the first conductive thread 5 and the second conductive thread 6.

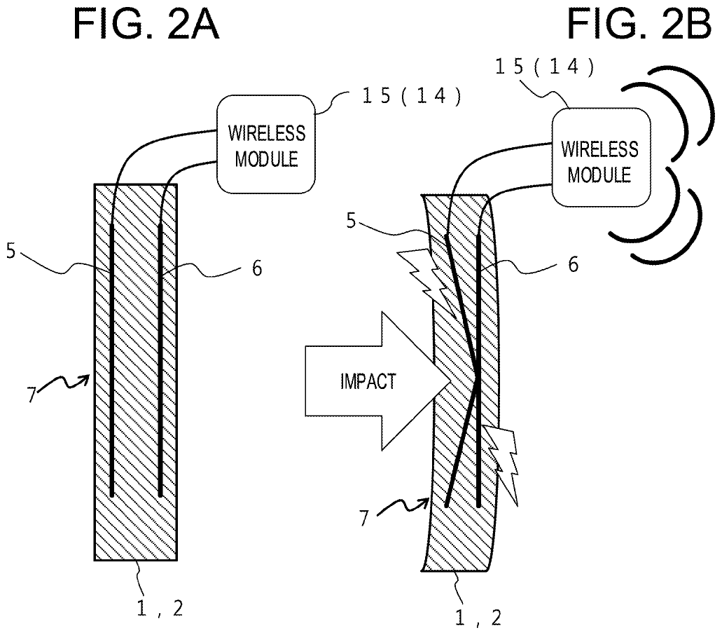

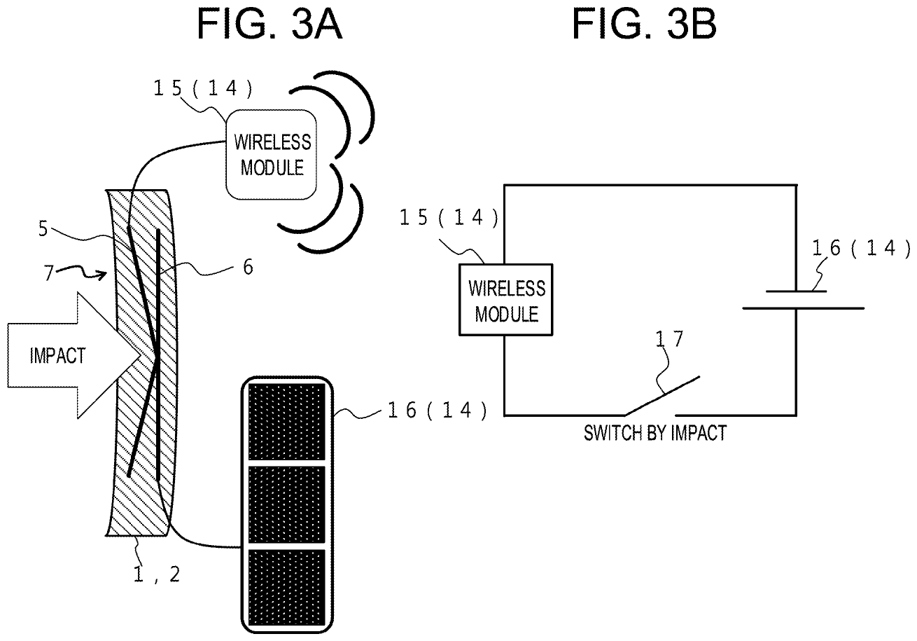

In the embodiment, for example, the pressure detection cloth 7 is provided with a detection unit 14 that detects the pressure by the electrical connection between the first conductive thread 5 and the second conductive thread 6, as illustrated in FIGS. 2A, 2B, 3A, and 3B.

For example, as illustrated in FIGS. 2A and 2B, the detection unit 14 may include a wireless module 15 that transmits a radio signal when the pressure is detected by the electrical connection between the first conductive thread 5 and the second conductive thread 6. Further, the wireless module 15 may also be referred to as a wireless unit. In addition, FIGS. 2A and 2B schematically illustrate the pressure detection cloth 7.

As described above, the pressure detection cloth 7 is provided with the detection unit 14 including the wireless module 15, so that when the pressure is applied to the pressure detection cloth 7 illustrated in FIG. 2A in the direction perpendicular to the cloth surface as illustrated in FIG. 2B, the first conductive thread 5 and the second conductive thread 6 are electrically connected to each other, the pressure is detected by the electrical connection, and as a result, the wireless module 15 transmits the radio signal.

As illustrated in FIGS. 3A and 3B, for example, the detection unit 14 may include a power supply 16 that is electrically connected to one of the first conductive thread 5 and the second conductive thread 6, and the wireless module 15 that is electrically connected to the other of the first conductive thread 5 and the second conductive thread 6 and transmits the radio signal when the pressure is detected by the electrical connection between the first conductive thread 5 and the second conductive thread 6. Further, the power supply 16 may also be referred to as a power supply unit. In addition, the wireless module 15 may also be referred to as a wireless unit.

According to the configuration described above, as illustrated in FIG. 3A, when the pressure detection cloth 7 receives a predetermined magnitude or more of pressure, the first conductive thread 5 and the second conductive thread 6 are short-circuited (that is, a switch 17 is pressed by the pressure; see FIG. 3B). As a result, current flows to the wireless module 15 from the power supply 16 through the first conductive thread 5 and the second conductive thread 6, and the radio signal is transmitted from the wireless module 15.

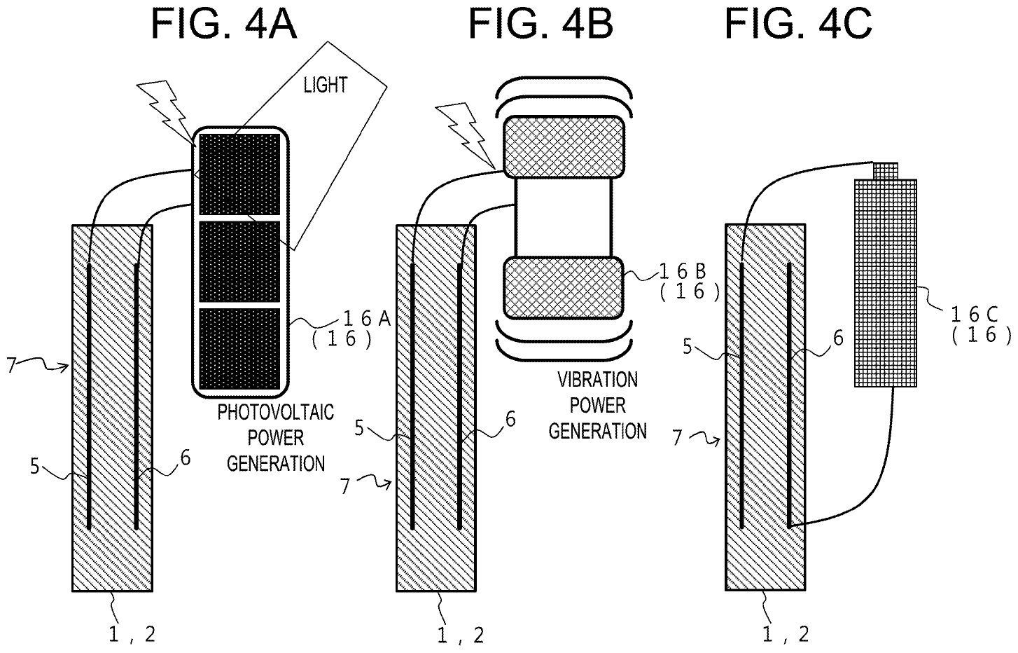

Here, for example, as the power supply 16, as illustrated in FIG. 4A, a solar cell (a photovoltaic power generation device) 16A may be used. For example, as illustrated in FIG. 4B, a vibration power generation element (a vibration power generation device) 16B may be used. For example, as illustrated in FIG. 4C, a cell 16C may be used. However, from the viewpoint of making a cell replacement unnecessary, the power supply 16 is preferably, for example, the solar cell or the vibration power generation element.

In this case, it may be understood that the sensor for detecting the pressure includes the power supply 16 such as the solar cell or the vibration power generation element, the wireless module 15 that transmits the radio signal, and the pressure detection unit that detects the pressure through the contact between the conductive threads as the conductors by the pressure, and the pressure detection unit is constituted by the first conductive thread 5 and the second conductive thread 6 sewn or woven into the fabric and includes the gap portion 4 and the support members 3X between the first conductive thread 5 and the second conductive thread 6, so as to transmit the radio signal from the wireless module 15 when the pressure is detected.

In this way, the radio signal transmitted from the wireless module 15 may be received by a computer such as, for example, a personal computer (PC) or a server via a network such as, for example, a Local Area Network (LAN) or the Internet, so that various processes may be performed. In addition, the radio signal may be received by a terminal such as, for example, a smart phone or a wearable terminal, so that various processes may be performed.

The detection unit 14 is not limited to the configuration described above, and the detection unit 14 may include, for example, an alarm unit that issues an alarm when the pressure is detected by the electrical connection between the first conductive thread 5 and the second conductive thread 6.

The detection unit 14 configured as described above is provided in the pressure detection cloth 7. That is, the detection unit 14 configured as described above is integrally formed in the pressure detection cloth 7 configured as described above. Further, the present disclosure is not limited thereto, and the detection unit 14 configured as described above may be provided separately from the pressure detection cloth 7 configured as described above, and the detection unit 14 and the pressure detection cloth 7 may be electrically connected to each other.

However, the pressure detection cloth 7 configured as described above may constitute, for example, a part of clothes or may be configured to be attached to an object which is desired to have the pressure detection function.

For example, when the pressure detection cloth 7 is configured to be attached to the object, the pressure detection cloth 7 configured as described above may have an attachment portion to be attached to the object. Here, it is preferable that the attachment portion may be peeled/rebonded, such as a magic tape (registered trademark).

Next, a method for manufacturing the pressure detection cloth configured as described above will be described with reference to FIGS. 5A and 5B to FIGS. 9A and 9B.

That is, first, as illustrated in FIGS. 5A and 5B, the first cloth 8 and the second cloth 9 having the plurality of first openings 10 are prepared, and as illustrated in FIGS. 6A and 6B, the first cloth 8 and the second cloth 9 are bonded to each other by, for example, an adhesive or sewing, so as to manufacture the first cloth portion 1.

Similarly, the third cloth 11 and the fourth cloth 12 having the plurality of second openings 13 are prepared and bonded to each other by, for example, an adhesive or sewing, so as to manufacture the second cloth portion 2.

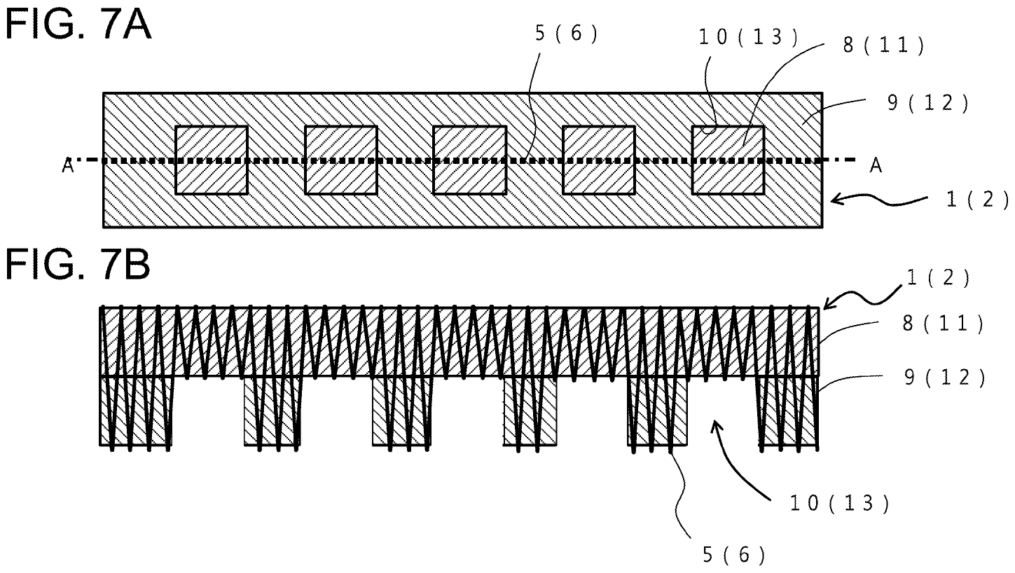

Next, as illustrated in FIGS. 7A and 7B, the first conductive thread 5 is sewed between one surface of the first cloth 8 and one surface of the second cloth 9 which are located on both sides of the first cloth portion 1 in the thickness direction of the first cloth portion 1. Here, the first conductive thread 5 is sewed linearly from one side toward the other side of the first cloth portion 1 (from one side toward the other side in the left-right direction in the drawing) while passing through the centers of the plurality of first openings 10 and the portions formed among the plurality of first openings 10, so that the first cloth 8 and the second cloth 9 are bonded to each other.

Similarly, the second conductive thread 6 is sewed between one surface of the third cloth 11 and one surface of the fourth cloth 12 which are located on both sides of the second cloth portion 2 in the thickness direction of the second cloth portion 2. Here, the second conductive thread 6 is sewed linearly from one side toward the other side of the second cloth portion 2 (from one side toward the other side in the left-right direction in the drawing) while passing through the centers of the plurality of second openings 13 and the portions formed among the plurality of second openings 13, so that the third cloth 11 and the fourth cloth 12 are bonded to each other.

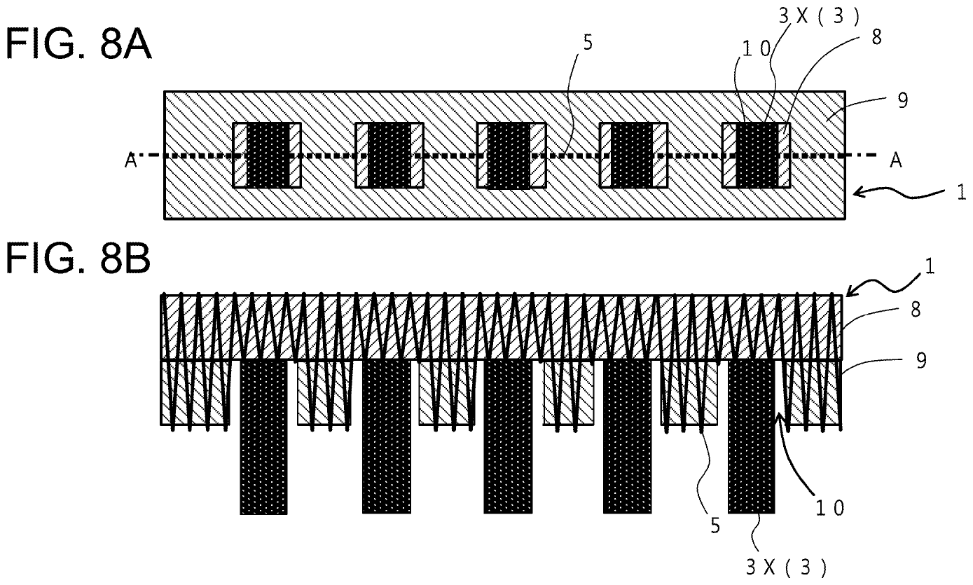

Next, as illustrated in FIGS. 8A, 8B, 9A, and 9B, the first cloth portion 1 and the second cloth portion 2 are made into a state where the plurality of first openings 10 and the plurality of second openings 13 are opposed to each other, respectively, and the support members 3X are installed in the spaces configured by the opposing first openings 10 and second openings 13, respectively. In addition, in this state, the first cloth portion 1 and the second cloth portion 2 are bonded to each other such that the gap portion 4 is formed between the plurality of support members 3X, and the first conductive thread 5 and the second conductive thread 6 are formed on the surfaces opposed to each other in the thickness direction of the first cloth portion 1 (or the second cloth portion 2), that is, the surfaces exposed to the gap portion 4 and opposed to each other in the direction perpendicular to the cloth surface, respectively.

That is, first, as illustrated in FIGS. 8A and 8B, the support members 3X are inserted into the plurality of first openings 10 of the first cloth portion 1, respectively. Further, the first openings 10 may also be referred to as first concaves. In addition, the support members 3X may also be referred to as spacer members.

Next, as illustrated in FIGS. 9A and 9B, the first cloth portion 1 in which the first conductive thread 5 is sewed and the support members 3X are inserted into the plurality of first openings 10, respectively, is bonded to the second cloth portion 2 in which the second conductive thread 6 is sewed and the plurality of second openings 13 are formed. Here, the first cloth portion 1 and the second cloth portion 2 are bonded to each other such that the plurality of first openings 10 and the plurality of second openings 13 are opposed to each other, respectively, and the support members 3X are installed in the spaces configured by the opposing first openings 10 and second openings 13, respectively.

In this way, the first cloth portion 1 and the second cloth portion 2 are made into the state where the plurality of first openings 10 and the plurality of second openings 13 are opposed to each other, respectively, and the support members 3X are installed in the spaces configured by the opposing first openings 10 and second openings 13, respectively. In addition, in this state, the first cloth portion 1 and the second cloth portion 2 are bonded to each other such that the gap portion 4 is formed between the plurality of support members 3X, and the first conductive thread 5 and the second conductive thread 6 are formed on the surfaces opposed to each other in the thickness direction of the first cloth portion 1 (or the second cloth portion 2), that is, the surfaces exposed to the gap portion 4 and opposed to each other in the direction perpendicular to the cloth surface, respectively.

In this way, the pressure detection cloth 7 configured as described above may be manufactured. In the meantime, the above description is for the following reason. For example, in the pressure detection which is performed in, for example, a factory for safety, when an individual wears a pressure detection device, a pressure detection device which is attached or assembled to, for example, clothes are used.

However, the pressure detection device of the related art is configured by, for example, a pressure sensor, a battery, and a circuit, requires a battery replacement, and has a problem such as a failure of the device.

When the pressure detection cloth 7 using the conductive threads 5 and 6 configured as described above is used as the pressure detection sensor, the pressure detection cloth 7 has the flexibility so that it is possible to provide the resistance to the failure of the device. That is, for example, since the conductive threads 5 and 6 are sewed into a cloth such as clothes to be used as the pressure detection sensor, the circuit hardly breaks down due to the flexibility of the conductive threads 5 and 6 so that the pressure detection sensor may hardly be failed.

As described above, it may be unnecessary to replace the battery by assembling, as the power supply 16, a power generating device such as a solar cell or a vibration cell (e.g., a photovoltaic power generation device 16A or a vibration power generation device 16B; see, e.g., FIGS. 4A and 4B). In addition, even in the case of the configuration as described above, a battery 16C may be used as long as there is no problem in replacing the battery (see, e.g., FIG. 4C).

In the embodiment described above, the spacer portion 3 of the pressure detection cloth 7 is configured by the support members 3X made of a different material from that of the other portion of the pressure detection cloth 7, but the present disclosure is not limited thereto. For example, the spacer portion 3 may be configured by the same cloth as that of the other portion of the pressure detection cloth 7. That is, the entirety of the pressure detection cloth 7 may be configured by cloth, and a part thereof may function as the spacer portion 3. In this case as well, the pressure detection cloth 7 is deformed in the direction perpendicular to the cloth surface by the pressure, so that the gap portion 4 is closed and the first conductive thread 5 and the second conductive thread 6 formed on the opposing surfaces, respectively, are electrically connected to each other. Therefore, the pressure may be detected.

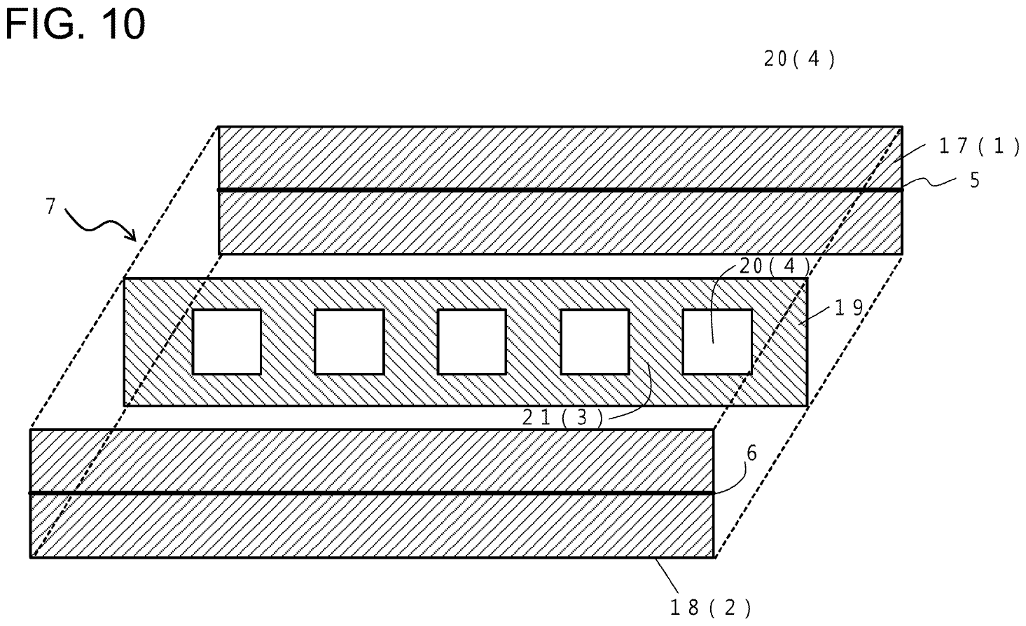

For example, the pressure detection cloth 7 may be configured as illustrated in FIG. 10. In this case, the first cloth portion 1 is configured by a first cloth 17. Further, the second cloth portion 2 is configured by a second cloth 18. In addition, the pressure detection cloth 7 further includes a third cloth 19 that is bonded while being interposed between the first cloth 17 and the second cloth 18 and has an opening 20. Further, the spacer portion 3 is configured by a peripheral portion 21 of the opening 20 of the third cloth 19. In addition, the gap portion 4 is configured by the opening 20 of the third cloth 19. Further, the first conductive thread 5 is sewed between both lateral surfaces of the first cloth 17 in the thickness direction of the first cloth 17. In addition, the second conductive thread 6 is sewed between both lateral surfaces of the second cloth 18 in the thickness direction of the second cloth 18. Further, the first conductive thread 5 and the second conductive thread 6 are formed on the surfaces opposed to each other in the thickness direction of the first cloth portion 1 (or the second cloth portion 2), that is, the surfaces exposed to the opening 20 and opposed to each other in the direction perpendicular to the cloth surface, respectively.

Here, a plurality of openings is formed as the opening 20. Further, here, the plurality of openings 20 are formed at regular intervals. The present disclosure is not limited thereto and, for example, one opening may be formed as the opening 20. Further, here, the cross-sectional shape of the opening 20 may be the quadrangular shape, but is not limited thereto. For example, the cross-sectional shape of the opening 20 may have other shapes such as a circular shape.

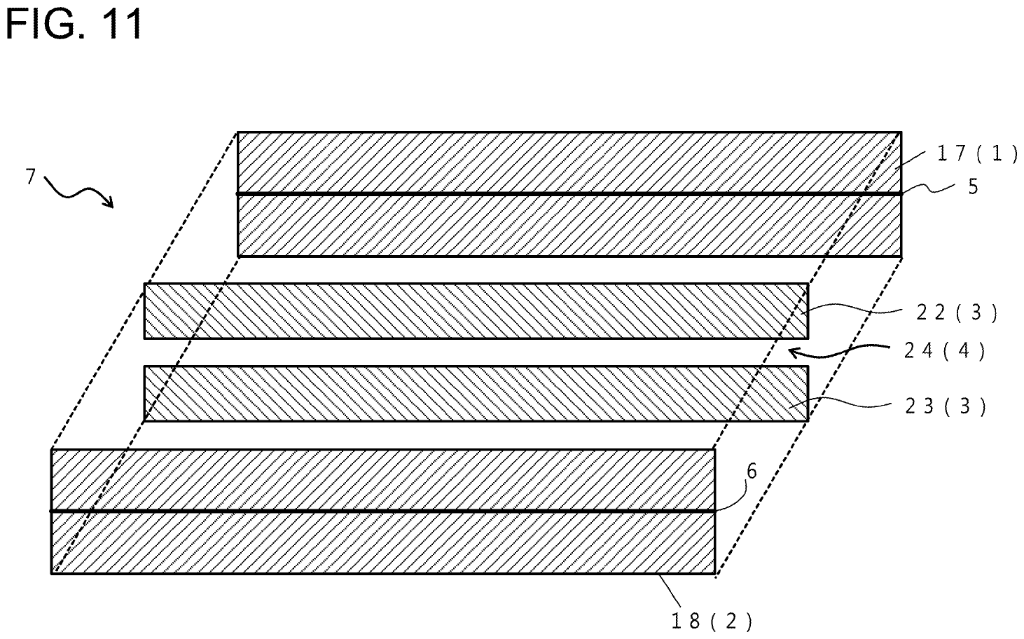

For example, the pressure detection cloth 7 may be configured as illustrated in FIG. 11. In this case, the first cloth portion 1 is configured by the first cloth 17. Further, the second cloth portion 2 is configured by the second cloth 18. In addition, the spacer portion 3 is configured by a third cloth 22 and a fourth cloth 23 that are bonded while being interposed between the first cloth 17 and the second cloth 18. Further, the gap portion 4 is configured by a gap between the third cloth 22 and the fourth cloth 23. In addition, the first conductive thread 5 is sewed between both lateral surfaces of the first cloth 17 in the thickness direction of the first cloth 17. Further, the second conductive thread 6 is sewed between both lateral surfaces of the second cloth 18 in the thickness direction of the second cloth 18. In addition, the first conductive thread 5 and the second conductive thread 6 are formed on the surfaces opposed to each other in the thickness direction of the first cloth portion 1 (or the second cloth portion 2), that is, the surfaces exposed to the gap 24 and opposed to each other in the direction perpendicular to the cloth surface, respectively.

In the embodiment described above, the pressure detection cloth 7 is configured to detect the pressure in the thickness direction of the first cloth portion 1 (or the second cloth portion 2) (the direction perpendicular to the cloth surface; the vertical direction to the fabric; the thickness direction of the cloth; the cross-sectional direction of the cloth), but is not limited thereto. The pressure detection cloth 7 may be configured to detect the pressure in the direction perpendicular to the thickness direction of the first cloth portion 1 (or the second cloth portion 2) (the direction parallel to the cloth surface; the planar direction to the fabric; the in-plane direction of the cloth).

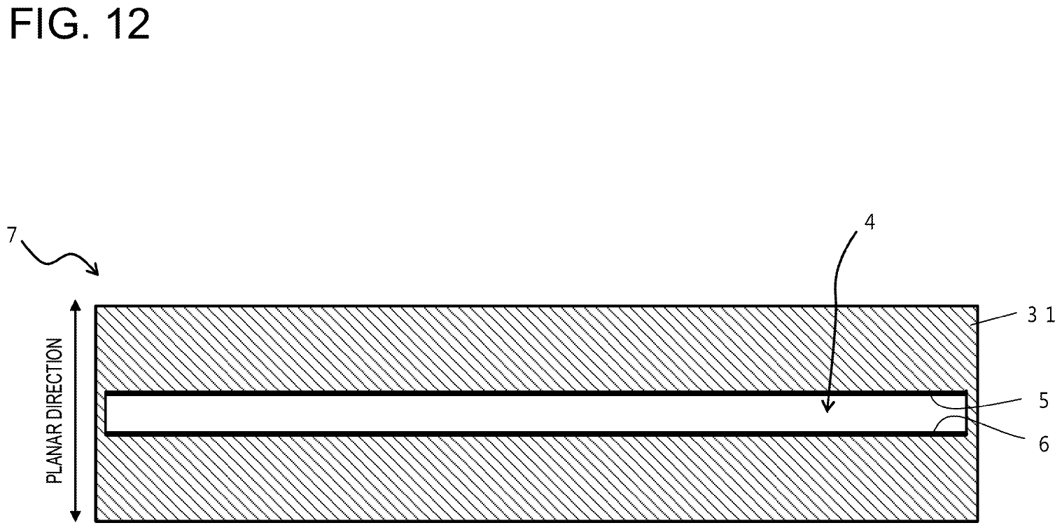

For example, as illustrated in FIG. 12, the pressure detection cloth 7 may be configured to include a cloth portion 31, the gap portion 4 formed in the cloth portion 31, and the first conductive thread 5 and the second conductive thread 6 that are formed on the surfaces exposed to the gap portion 4 and opposed to each other in the direction perpendicular to the thickness direction of the cloth portion 31 (the direction parallel to the cloth surface), respectively, and are electrically connected to each other by the pressure in the direction perpendicular to the thickness direction of the cloth portion 31 (the direction parallel to the cloth surface).

In this case, the pressure detection cloth 7 is deformed in the direction parallel to the cloth surface by the pressure, so that the gap portion 4 is closed and the first conductive thread 5 and the second conductive thread 6 provided on the opposing surfaces, respectively, are electrically connected to each other. Therefore, the pressure may be detected. Further, it is possible to change the sensitivity of pressure detection according to the size of the gap portion 4, that is, the distance between the surfaces exposed to the gap portion 4 and opposed to each other.

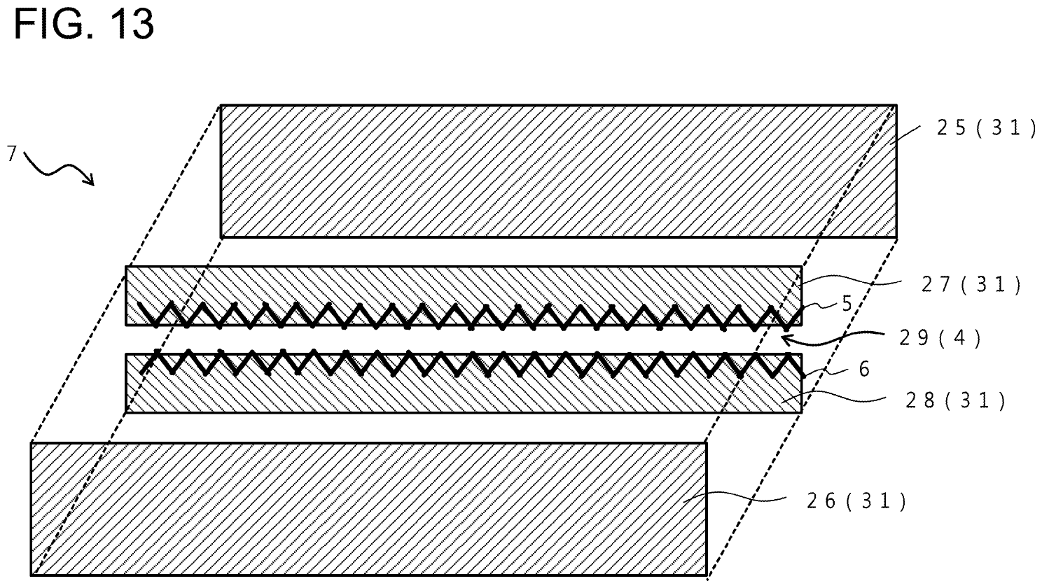

Specifically, for example, the pressure detection cloth 7 may be configured as illustrated in FIG. 13. In this case, the cloth portion 31 is constituted by a first cloth 25, a second cloth 26, and a third cloth 27, and a fourth cloth 28 that are bonded while being interposed between the first cloth 25 and the second cloth 26. Further, the gap portion 4 is configured by a gap 29 between the third cloth 27 and the fourth cloth 28. In addition, the first conductive thread 5 is sewed at an edge of the third cloth 27. Further, the second conductive thread 6 is sewed at an edge of the fourth cloth 28. In addition, the first conductive thread 5 and the second conductive thread 6 are formed on the surfaces opposed to each other in the thickness direction of the cloth portion 31, that is, the surfaces exposed to the gap 29 and opposed to each other in the direction parallel to the cloth surface, respectively.

Here, the first conductive thread 5 may be sewed at the edge of the third cloth 27 by, for example, over edging. Further, the second conductive thread 6 may be sewed at the edge of the fourth cloth 28 by, for example, the over edging.

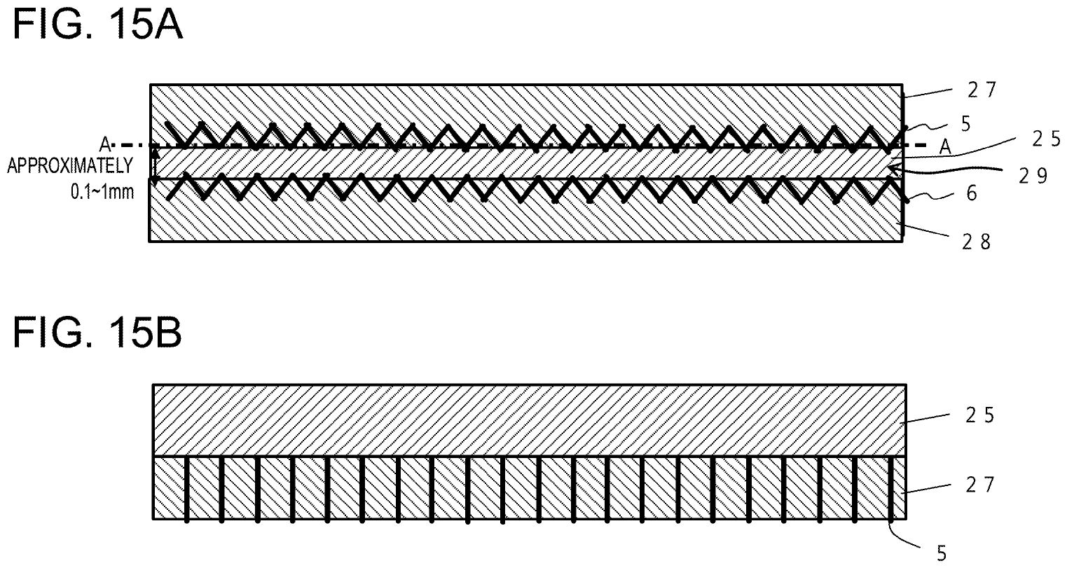

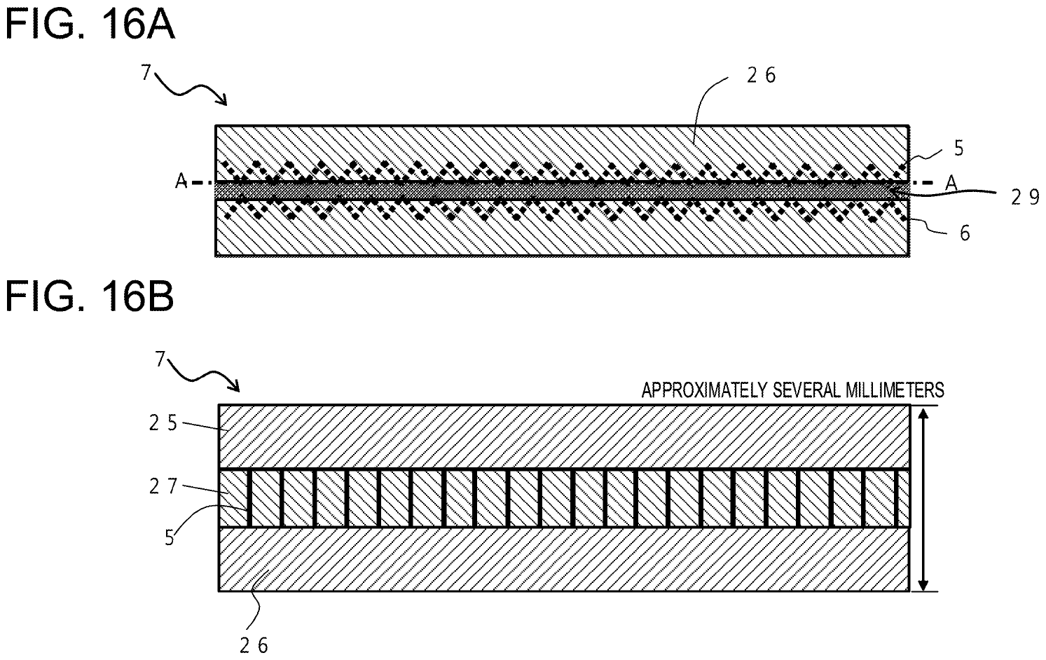

In addition, the thickness of the pressure detection cloth 7 in which the third cloth 27 and the fourth cloth 28 are bonded while being interposed between the first cloth 25 and the second cloth 26 is approximately several mm (see, for example, FIG. 16B), and the gap 29 formed between the third cloth 27 and the fourth cloth 28 is approximately 0.1 mm to approximately 1 mm (see, e.g., FIG. 15A).

In this case as well, the first conductive thread 5 may be formed from one side toward the other side of the first cloth portion 1 (from one side toward the other side in the left-right direction in FIGS. 12 and 13). In addition, the second conductive thread 6 may be formed from one side toward the other side of the second cloth portion 2 (from one side toward the other side in the left-right direction in FIGS. 12 and 13) along the first conductive thread 5. In the configuration described above, the support members 3X used in the embodiment described above may not be installed.

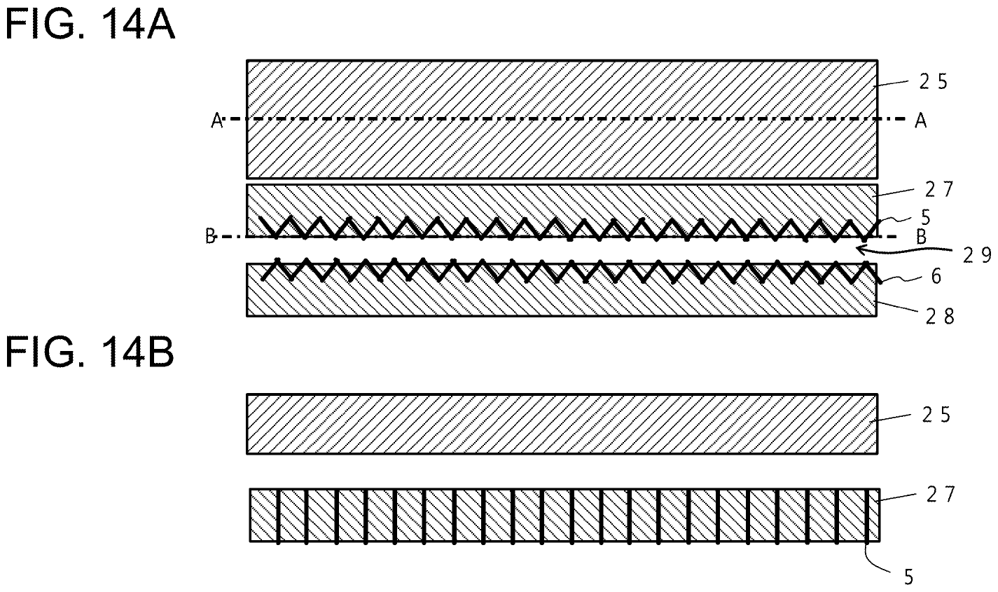

The pressure detection cloth 7 having such a configuration may be manufactured as described below. That is, first, as illustrated in FIGS. 14A and 14B, the first cloth 25, the third cloth 27 in which the first conductive thread 5 is sewed at the edge by, for example, an over edging, and the fourth cloth 28 in which the second conductive thread 6 is sewed at the edge by, for example, an over edging are prepared. Then, as illustrated in FIGS. 15A and 15B, the third cloth 27 is positioned on the upper portion of the first cloth 25 while the side of the third cloth 27 at which the first conductive thread 5 is formed faces downward, and the fourth cloth 28 is positioned on the lower portion of the first cloth 25 while the side of the fourth cloth 28 at which the second conductive thread 6 is formed faces upward. In this state, the first, third, and fourth cloths 25, 27, and 28 are bonded to each other by, for example, an adhesive or sewing.

Here, the third cloth 27 and the fourth cloth 28 are bonded to the first cloth 25 such that the gap 29 of approximately 0.1 mm to approximately 1 mm is opened between the third cloth 27 and the fourth cloth 28.

Next, as illustrated in FIGS. 16A and 16B, in the state where the third cloth 27 and the fourth cloth 28 are bonded to the first cloth 25 as described above, the second cloth 26 is bonded to the opposite side of the first cloth 25 while the third cloth 27 and the fourth cloth 28 are interposed between the first cloth 25 and the second cloth 26 by, for example, an adhesive or sewing. Further, in FIG. 16A, the second cloth 26 is overlapped and stacked on the configuration illustrated in FIG. 15A, and the first conductive thread 5, the second conductive thread 6, and the gap 29 are also illustrated in order to make the positional relationship easier to understand.

In this way, the pressure detection cloth 7 configured as described above may be manufactured. Here, the thickness of the pressure detection cloth 7 in which the third cloth 27 and the fourth cloth 28 are bonded while being interposed between the first cloth 25 and the second cloth 26 is approximately several millimeters. The present disclosure is not limited thereto, and similarly to the case of the embodiment described above, the support members 3X as the spacer portion 3 may be provided.

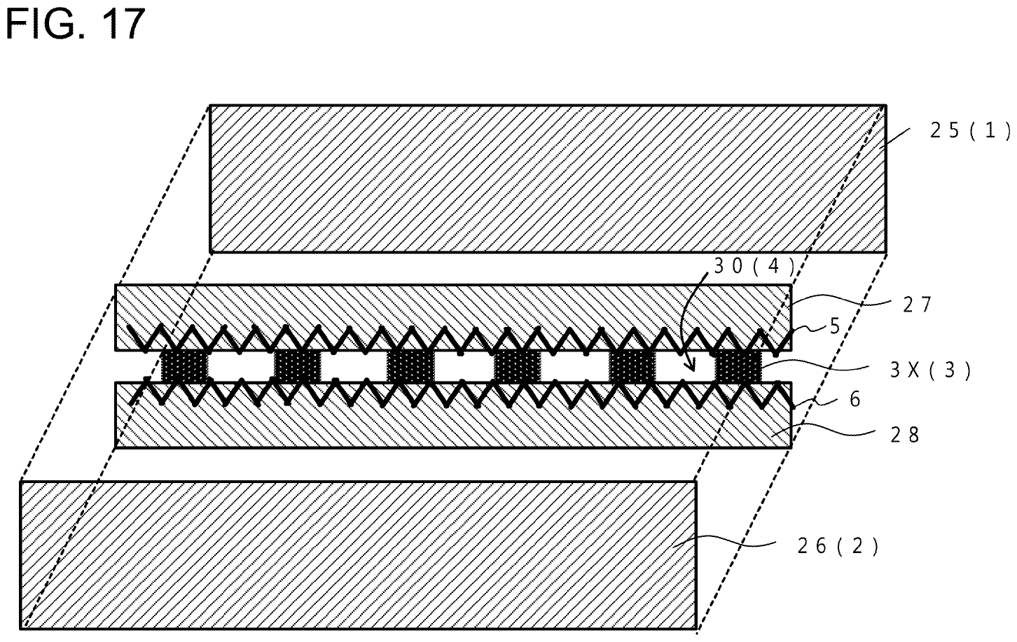

For example, as illustrated in FIG. 17, the pressure detection cloth 7 includes the first cloth portion 1, the second cloth portion 2, the spacer portion 3 formed between the first cloth portion 1 and the second cloth portion 2, the gap portion 4 formed by the spacer portion 3 between the first cloth portion 1 and the second cloth portion 2, and the first conductive thread 5 and the second conductive thread 6 that are formed on the surfaces exposed to the gap portion 4 and opposed to each other, as the surfaces of the first cloth portion 1 and the second cloth portion 2, respectively, and are electrically connected to each other by the pressure.

The surfaces exposed to the gap portion 4 and opposed to each other are the surfaces opposed to each other in the direction perpendicular to the thickness direction of the first cloth portion 1 (or the second cloth portion 2), that is, the surfaces exposed to the gap portion 4 and opposed to each other in the direction parallel to the cloth surface. The first conductive thread 5 and the second conductive thread 6 are electrically connected to each other by the pressure in the direction perpendicular to the thickness direction of the first cloth portion 1 (or the second cloth portion 2), that is, in the direction parallel to the cloth surface.

The first cloth portion 1 may be configured by the first cloth 25, and the second cloth portion 2 may be configured by the second cloth 26. Further, the spacer portion 3 may be configured by the support members 3X installed between the third cloth 27 and the fourth cloth 28 which are bonded while being interposed between the first cloth 25 and the second cloth 26. In addition, the gap portion 4 may be configured by a gap 30 between the third cloth 27 and the fourth cloth 28. Further, the first conductive thread 5 may be sewed at the edge of the third cloth 27, the second conductive thread 6 may be sewed at the edge of the fourth cloth 28, and the first conductive thread 5 and the second conductive thread 6 may be formed on the surfaces opposed to each other in the direction perpendicular to the thickness direction of the first cloth portion 1 (or the second cloth portion 2), that is, the surfaces exposed to the gap 30 and opposed to each other in the direction parallel to the cloth surface, respectively.

Therefore, it is possible to change the sensitivity of the pressure detection according to not only the size of the gap portion 4, that is, the distance between the surfaces exposed to the gap portion 4 and opposed to each other, but also, for example, the hardness, elastic modulus, or size of the support members 3X such as hardness or size of the rubber.

Therefore, by the pressure detection cloth according to the embodiment, when the pressure is detected by using the conductive threads 5 and 6, the sensitivity of the detection of the pressure may be changed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A pressure detection cloth comprising:
a first cloth;
a second cloth;
a spacer formed between the first cloth and the second cloth;
a gap formed by the spacer between the first cloth and the second cloth;
a first conductive thread formed over a first surface exposed to the gap of the first cloth; and
a second conductive thread formed over a second surface exposed to the gap of the second cloth,
wherein the first surface and the second surface are opposed to each other, and
wherein the first conductive thread and the second conductive thread are coupled to each other by a pressure of at least the first cloth and the second cloth.

2. The pressure detection cloth according to claim 1,
wherein the first conductive thread is formed from a first side of the first cloth toward a second side of the first cloth, and
wherein the second conductive thread is formed, along the first conductive thread, from a third side of the second cloth toward a fourth side of the second cloth.

3. The pressure detection cloth according to claim 2,
wherein the first surface and the second surface are opposed to each other in a thickness direction of the first cloth, and
wherein the first conductive thread and the second conductive thread are electrically coupled to each other by the pressure in the thickness direction of the first cloth.

4. The pressure detection cloth according to claim 3,
wherein the first conductive thread is sewed between the first surface and a third surface of the first cloth in the thickness direction of the first cloth, and
wherein the second conductive thread is sewed between the second surface and a fourth surface of the second cloth in the thickness direction of the second cloth.

5. The pressure detection cloth according to claim 3,
wherein the spacer is configured to include a plurality of support members,
wherein the first cloth is configured to include a first sub-cloth and a second sub-cloth configured to include a plurality of first openings,
wherein the second cloth is configured to include a third sub-cloth and a fourth sub-cloth configured to include a plurality of second openings,
wherein the first conductive thread is sewed between a surface of the first sub-cloth and a surface of the second sub-cloth which are located over both sides of the first cloth in the thickness direction of the first cloth,
wherein the second conductive thread is sewed between a surface of the third sub-cloth and a surface of the fourth sub-cloth which are located over both sides of the second cloth in the thickness direction of the second cloth, and
wherein the first cloth and the second cloth are bonded to each other such that the plurality of first openings and the plurality of second openings are opposed to each other, and the plurality of support members are provided in spaces formed by the plurality of first openings and the plurality of second openings, the gap is formed between the plurality of support members, and the first conductive thread and the second conductive thread are formed over the first surface and the third surface opposed to each other in the thickness direction of the first cloth.

6. The pressure detection cloth according to claim 3, further comprising:
a third cloth,
wherein the first cloth is configured to include a first sub-cloth,
wherein the second cloth is configured to include a second sub-cloth,
wherein the third cloth is configured to be bonded while being interposed between the first sub-cloth and the second sub-cloth and having an opening,
wherein the spacer is configured to include a peripheral portion of the opening of the third cloth,
wherein the gap is configured to include the opening of the third cloth,
wherein the first conductive thread is sewed between both lateral surfaces of the first sub-cloth in the thickness direction of the first sub-cloth,
wherein the second conductive thread is sewed between both lateral surfaces of the second sub-cloth in the thickness direction of the second sub-cloth, and
wherein the first conductive thread and the second conductive thread are formed on the first surface and the third surface opposed to each other in the thickness direction of the first cloth.

7. The pressure detection cloth according to claim 3, further comprising:
a third cloth; and
a fourth cloth,
wherein the first cloth is configured to include a first sub-cloth,
wherein the second cloth is configured to include a second sub-cloth,
wherein the spacer is configured to include the third cloth and the fourth cloth that are bonded while being interposed between the first sub-cloth and the second sub-cloth,
wherein the gap is configured to include a space between the third cloth and the fourth cloth,
wherein the first conductive thread is sewed between both lateral surfaces of the first cloth in the thickness direction of the first cloth,
wherein the second conductive thread is sewed between both lateral surfaces of the second cloth in the thickness direction of the second cloth, and
wherein the first conductive thread and the second conductive thread are formed on the first surface and the third surface opposed to each other in the thickness direction of the first cloth.

8. The pressure detection cloth according to claim 1,
wherein the first surface and the second surface exposed to the gap and opposed to each other are opposed to each other in a direction perpendicular to the thickness direction of the first cloth, and
wherein the first conductive thread and the second conductive thread are electrically coupled to each other by the pressure in the direction perpendicular to the thickness direction of the first cloth.

9. The pressure detection cloth according to claim 8, further comprising:
a third cloth; and
a fourth cloth,
wherein the first cloth is configured to include a first sub-cloth,
wherein the second cloth portion is configured to include a second sub-cloth,
wherein the spacer is configured to include a plurality of support members provided between the third cloth and the fourth cloth that are bonded while being interposed between the first sub-cloth and the second sub-cloth,
wherein the gap is configured to include a space between the third cloth and the fourth cloth,
wherein the first conductive thread is sewed at an edge of the third cloth,
wherein the second conductive thread is sewed at an edge of the fourth cloth, and
wherein the first conductive thread and the second conductive thread are formed on the first surface and the third surface opposed to each other in a direction perpendicular to the thickness direction of the first cloth.

10. The pressure detection cloth according to claim 1, further comprising:
a detector configured to detect the pressure by an electrical connection between the first conductive thread and the second conductive thread.

11. The pressure detection cloth according to claim 10,
wherein the detector is configured to include a wireless module configured to transmit a radio signal when the pressure is detected.

12. The pressure detection cloth according to claim 10,
wherein the detector is configured to include a power supply electrically coupled to one of the first conductive thread and the second conductive thread, and a wireless module electrically coupled to another of the first conductive thread and the second conductive thread, the wireless module transmitting a radio signal when the pressure is detected.

13. The pressure detection cloth according to claim 1,
wherein the pressure detection cloth configures a part of clothes.

14. The pressure detection cloth according to claim 1, further comprising:
an attachment attached to an object for detecting the pressure.

15. A pressure detection cloth comprising:
a cloth;
a gap formed in the cloth; and
a first conductive thread and a second conductive thread formed on surfaces exposed to the gap and opposed to each other in a direction perpendicular to a thickness direction of the cloth, respectively, as surfaces of the cloth, and coupled electrically to each other by a pressure in the direction perpendicular to the thickness direction of the cloth.

16. The pressure detection cloth according to claim 15,
wherein the cloth is configured to include a first cloth, a second cloth, a third cloth, and a fourth cloth, the third cloth and the fourth cloth being bonded while being interposed between the first cloth and the second cloth,
wherein the gap is configured to include a space between the third cloth and the fourth cloth,
wherein the first conductive thread is sewed at an edge of the third cloth,
wherein the second conductive thread is sewed at an edge of the fourth cloth, and
wherein the first conductive thread and the second conductive thread are formed on the surfaces opposed to each other in the direction perpendicular to the thickness direction of the cloth, respectively.
